(19) United States
(12) Patent Application Publication
(10) Pub. No.: US 2022/0190757 A1
(43) Pub. Date: Jun. 16, 2022

(54) METHOD FOR OPERATING AN ELECTRIC MACHINE, APPARATUS

(71) Applicant: Robert Bosch GmbH, Stuttgart (DE)

(72) Inventors: Stefan Gering, Weissach (DE); Maximilian Manderla, Ludwigsburg (DE)

(21) Appl. No.: 17/607,257

(22) PCT Filed: Mar. 18, 2020
(86) PCT No.: PCT/EP2020/057383

§ 371 Date: Oct. 28, 2021

(30) Foreign Application Priority Data
Apr. 29, 2019 (DE) 10 2019 206 074.9

(51) Int. Cl. H02P 6/34; H02K 3/28; H02K 11/33

(52) U.S. Cl. CPC H02P 6/34; H02K 11/33; H02K 3/28

(57) ABSTRACT

The invention relates to a method for operating an electric machine (1), in particular of a motor vehicle, that has a stator (4) and a rotor (2), wherein the stator (4) has a stator winding (5) having at least three phases (U, V, W), and wherein the rotor is arranged/arrangeable on a rotor shaft (3), wherein a time-invariant differential equation modelling the machine (1) is taken as a basis for ascertaining a desired current value (I_{desired,fl}) for the stator winding (5) for producing a required torque and/or a required rotation speed, wherein the desired current value (I_{desired,fl}) is compared with an actual current value (I_{actual,fl}) of the stator winding (5), which actual current value corresponds to electric phase currents (I_{U}, I_{V}, I_{W}) flowing through the phases (U, V, W), and wherein the comparison is taken as a basis for passing current through the phases (U, V, W) such that a difference from the actual current value (I_{actual,fl}) to the desired current value (I_{desired,fl}) is reduced. There is provision for the time-invariant differential equation to be ascertained on the basis of a periodic, linear differential equation by means of a Floquet transformation.

### BACKGROUND OF THE INVENTION

The invention relates to a method for operating an electric machine, in particular of a motor vehicle, which has a stator and a rotor, wherein the stator has a stator winding with at least three phases, and wherein the rotor is arranged/arrangeable on a rotor shaft, wherein a desired current value of the stator winding for generating a required torque and/or a required speed is determined on the basis of a time-invariant differential equation modeling the machine, wherein the desired current value is compared with an actual current value of the stator winding, which corresponds to electric phase currents flowing through the phases, and wherein, on the basis of the comparison, the phases are energized such that a deviation of the actual current value from the desired current value is reduced.

The invention moreover relates to a device for implementing the method.

Electric machines generally have a rotor, which is arranged/arrangeable on a rotor shaft or drive shaft. A stator with a stator winding is provided to drive the rotor. The stator winding generally has at least three phases, which are arranged distributed around the rotor such that the rotor can be driven or rotated as a result of suitable energization of the phases.

To operate or regulate electric machines, it is known from the prior art to compare a desired current value of the stator winding with an actual current value of the stator winding and, on the basis of the comparison, to energize the phases of the stator winding such that a deviation of the actual current value from the desired current value is reduced. To this end, for example, electric voltages applied to the phases are altered. In this case, the actual current value is understood to be a current value which corresponds to electric phase currents flowing through the phases. By way of example, the actual current value is a current vector determined on the basis of the phase currents. The desired current value is a variable whereof the dimension corresponds to the dimension of the actual current value. The desired current value corresponds to phase currents which are needed for the electric machine to generate a required torque and/or a required speed. In this case, the desired current value is determined on the basis of a time-invariant differential equation modeling the machine. Time curves of the phase currents are preferably described by the time-invariant differential equation. An inductance of the electric machine is, in particular, contained in the time-invariant differential equation as a time-variant parameter. According to previously known methods, the time-invariant differential equation is generally determined by means of a dq transformation in this case.

### SUMMARY OF THE INVENTION

The inventive method has the advantage that the desired current value is accurately determined. In particular, as a result of the inventive procedure, it is achieved that the electric machine generates a ripple-free or constant torque. To this end, it is provided according to the invention that the time-invariant differential equation is determined on the basis of a periodic, linear time-variant differential equation by means of a Floquet transformation. A periodic, linear time-variant differential equation is understood to be a differential equation which, with the same input, has a different behavior at different points in time. In the case of an electric machine, the periodic, linear time-variant differential equation is a T-periodic system. According to the Floquet theory, a transformation, namely the Floquet transformation, then exists, by means of which the periodic, linear time-variant differential equation can be transformed into a time-invariant differential equation, i.e. a differential equation which, with the same input, has the same behavior at any time. In particular, the electric machine has a number of phases other than three. By way of example, the electric machine has more than three phases. In particular, at least two of the phases of the electric machine are spaced from one another through an angle other than 120°. Both the number of phases, which is other than three, and the angle between the phases, which is other than 120°, can be described by the periodic, linear time-variant differential equation. Since the Floquet transformation is used to determine the time-invariant differential equation, the time-invariant differential equation can also be determined on the basis of the periodic, linear time-variant differential equation in these cases.

According to a preferred embodiment, it is provided that the periodic, linear time-variant differential equation is determined on the basis of a speed and/or a torque of the electric machine. It is assumed that the periodic, linear time-variant differential equation is then also determined on the basis of the speed or the torque of the electric machine if the periodic, linear time-variant differential equation is determined on the basis of a variable corresponding to the speed and/or a variable corresponding to the torque. By taking into account the speed and/or the torque when determining the periodic, linear time-variant differential equation, the accuracy of the method is increased.

The periodic, linear time-variant differential equation is preferably determined on the basis of a system matrix of the electric machine, which describes an angle-dependent inductance of the stator winding. The angle-dependent inductance can be accurately represented by the system matrix. In particular, angles between the phases which are other than 120° and a number of phases which is other than three can be described by the system matrix.

In this case, the system matrix of the electric machine is preferably determined on the basis of a finite element model of the electric machine. An analog model of a magnetic field generated by the stator winding or an inductance of the stator winding can be accurately represented numerically by the finite element model. To this end, a model of the stator winding is divided into numerous small parts, so-called finite elements.

According to a preferred embodiment, it is provided that, to implement the Floquet transformation, an initial value is specified, wherein the time-invariant differential equation is determined on the basis of the initial value. The initial value is preferably specified for a real-valued matrix, which is part of the time-invariant differential equation. By specifying the initial value, the implementation or solution of the Floquet transformation is the result of an initial value problem.

According to a preferred embodiment, it is provided that a mean value of the system matrix is specified as the initial value. This relates to a particularly favorable initialization when determining the time-invariant differential equation.

According to a preferred embodiment, it is provided that an error of the time-invariant differential equation determined on the basis of the initial value is determined and in that the time-invariant differential equation is corrected until the error is smaller than a specified threshold value. A corrected time-invariant differential equation is therefore determined. On the one hand, it is thereby ensured that an at least substantially correct time-invariant differential equation is determined. By specifying the threshold value, the computing time involved in the correcting process is moreover reduced because the correction is terminated as soon as it is determined that the error is smaller than the threshold value.

The time-invariant differential equation is preferably corrected on the basis of a search method, in particular a downhill simplex method. The time-invariant differential equation can be reliably corrected thereby. If the downhill simplex method is implemented, the determination of derivations of the time-invariant differential equation is preferably omitted. The computing time involved in correcting the time-invariant differential equation is thus reduced.

Alternatively to this, the time-invariant differential equation is corrected on the basis of a gradient method, in particular a quasi-Newton method. The time-invariant differential equation can also be reliably corrected by means of the gradient method. If the time-invariant differential equation is corrected on the basis of the quasi-Newton method, the determination or calculation of a Hessian matrix of the time-invariant differential equation is preferably omitted. The computing time involved in correcting the time-invariant differential equation is also thereby reduced.

The inventive device for an electric machine, which has a stator and a rotor, wherein the stator has a stator winding with at least three phases, and wherein the rotor is arranged/arrangeable on a motor shaft, is characterized by the features of claim 10 in that the device is specifically designed as a control unit to implement the inventive method in normal use. The advantages mentioned above are also realized thereby. Further preferred features and feature combinations are revealed in the descriptions above and in the claims.

### BRIEF DESCRIPTION OF THE DRAWINGS

The invention is explained in more detail below with reference to the drawings. In this regard:

FIG. 1 shows an electric machine,

FIG. 2 shows curves of electric phase currents flowing through phases of the electric machine,

FIG. 3 shows curves of machine torques of the electric machine,

FIG. 4 shows a method for operating the electric machine.

### DETAILED DESCRIPTION

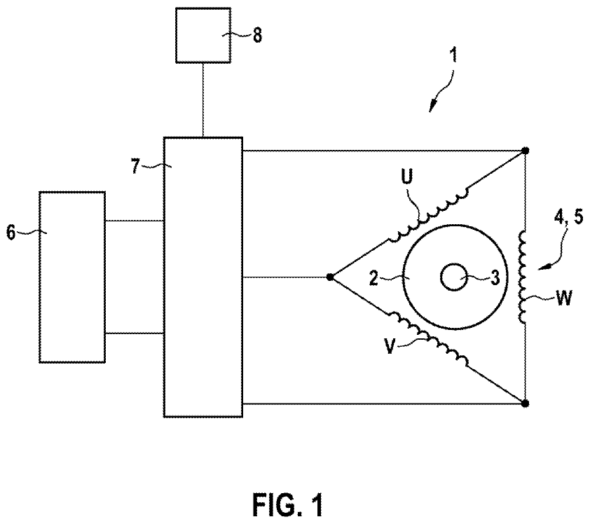

FIG. 1 shows an electric machine 1 in a schematic illustration. By way of example, the electric machine 1 is an electric synchronous machine excited by a permanent magnet. The electric machine 1 has a rotor 2, which is arranged on a rotor shaft 3. In the present case, the rotor shaft 3 is a drive shaft of a motor vehicle (not illustrated). The electric machine 1 moreover has a stator 4 with a stator winding 5. According to the exemplary embodiment illustrated in FIG. 1, the stator winding comprises three phases U, V and W. In the present case, the phases U, V and W are connected to one another via a delta connection. The phases U, V and W are arranged distributed around the rotor 2 such that the rotor 2 can be driven or rotated as a result of suitable energization of the phases U, V and W. According to further exemplary embodiments, a number of phases other than three is provided. Moreover, according to further exemplary embodiments, the phases are connected to one another via a different connection, for example a star connection.

An electric energy store 6 is associated with the electric machine 1. The energy store 6 is connected to the phases U, V and W by means of power electronics 7. A DC voltage supplied by the energy store 6 can be converted into AC voltages via the power electronics 7 to energize the phases U, V and W.

The electric machine 1 moreover has a device 8, which is designed as a control unit 8 to actuate the power electronics 7 or to switch switching elements (not illustrated) of the power electronics 7.

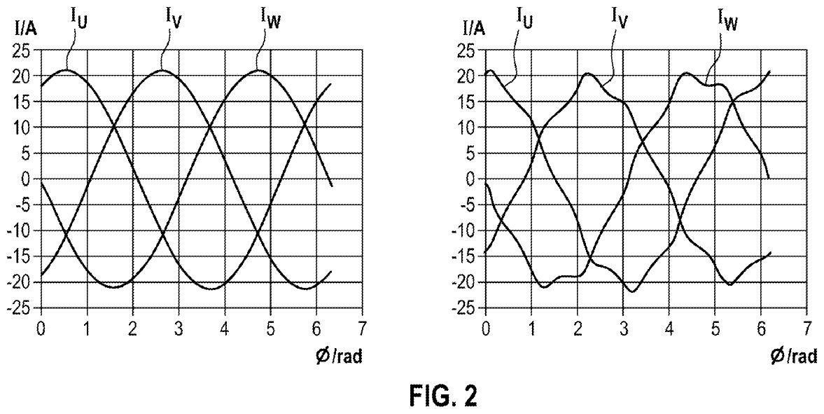

FIG. 2 shows two graphs in which curves of phase currents I_{U}, I_{V} and I_{W} flowing through the phases U, V and W of the electric machine 1 are shown. In this case, the phase current I_{U} is the phase current flowing through the phase U. The phase current I_{V} is the phase current flowing through the phase V. The phase current I_{W} is the phase current flowing through the phase W. In this case, a current value I of the phase currents is shown in amperes on the Y axis of the graphs. A rotational angle Φ of the rotor 2 is shown in radian on the X axis of the graphs.

According to the first graph shown on the left in FIG. 2, the phase currents I_{U}, I_{V} and I_{W} each have a sinusoidal curve. The phase currents I_{U}, I_{V} and I_{W} are moreover offset from one another through 120° or ⅔×π radian in each case. A sum of the phase currents I_{U}, I_{V} and I_{W} is the same for each rotational angle Φ.

According to the second graph shown on the right in FIG. 2, the phase currents I_{U}, I_{V} and I_{W} each have a curve which has a fundamental wave and at least one harmonic wave. The curve therefore deviates from a sinusoidal shape. The sum of the phase currents I_{U}, I_{V} and I_{W} differs depending on the rotational angle Φ.

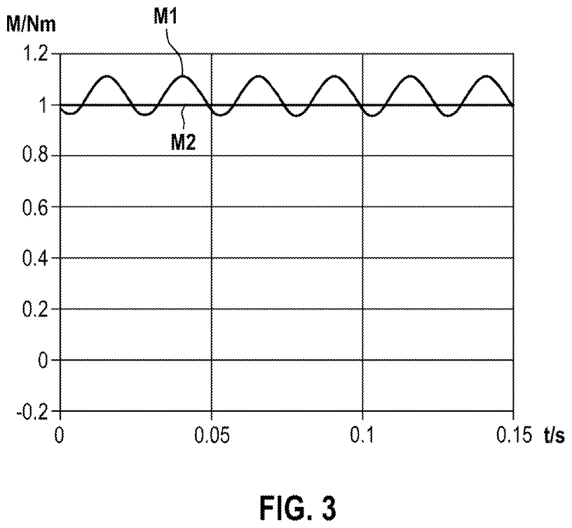

FIG. 3 shows a curve of machine torques of the electric machine 1 with the aid of a graph. In this case, the machine torque M is shown in Newton meters on the Y axis of the graph and the time t is shown in seconds on the X axis. If the sinusoidal phase currents I_{U}, I_{V} and I_{W} shown in the first graph of FIG. 2 flow through the phases U, V and W, this results in the machine torque curve M₁. As can be seen in FIG. 3, the machine torque curve M₁ is undulating. The undulating machine torque curve M₁ is the result of harmonic waves in the inductances of the electric machine 1. These are caused by the geometry of the electric machine 1 and/or by saturation effects. Therefore, if the power electronics 7 are actuated such that curves of the phase currents I_{U}, I_{V} and I_{W} are sinusoidal and are offset from one another through 120° in each case, a constant or ripple-free torque is not generated by the machine 1.

If the phase currents I_{U}, I_{V} and I_{W} shown in the second graph of FIG. 2 flow through the phases U, V and W, this results in the machine torque curve M₂. The machine torque curve M₂ is substantially ripple-free or constant. The phase currents I_{U}, I_{V} and I_{W} shown in the second graph of FIG. 2 therefore correspond to the phase currents which are needed for the electric machine 1 to generate a ripple-free torque.

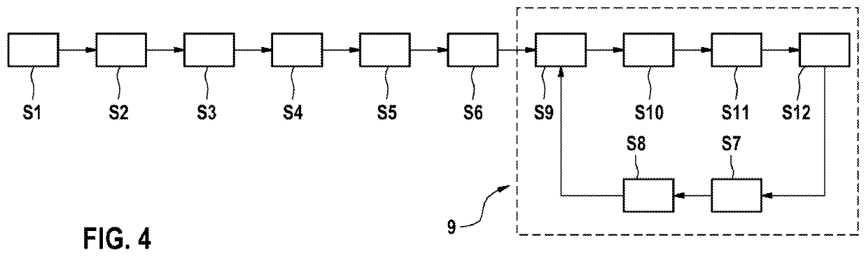

A method for operating the electric machine 1 is described below with reference to FIG. 4. As a result of the method, it is ensured that the phase currents I_{U}, I_{V} and I_{W} can be controlled or regulated such that a ripple-free torque is generated by the machine 1.

In a step S₁, a speed w of the rotor 2 or a variable corresponding to the speed ω, for example a rotational speed of the rotor 2, is determined. The speed ω is, for example, the current speed ω of the rotor 2. Alternatively, it is a possible speed ω of the rotor 2, which deviates from the current speed ω. Moreover, in step S₁, the determined speed ω or the variable is supplied to the device 8. In step S1, alternatively or additionally to the speed ω, a torque of the rotor 2 is determined and supplied to the device 8.

In a step S2, on the basis of the speed ω or the variable on the one hand and a system matrix A_{abc}(t) of the electric machine 1 on the other, the device 8 determines a periodic, linear time-variant differential equation with the following equation (1.1):

İ_{abc}=A_{abc}(t)I_{abc} (1.1)

In this case, the system matrix A_{abc}(t) is understood to be a matrix which describes an angle-dependent inductance of the electric machine 1. In particular, there is a non-linear association between the system matrix A_{abc}(t) and the inductance of the electric machine 1. I_{abc} is a current value which corresponds to the phase currents I_{U}, I_{V} and I_{W}. The current value I_{abc} represents the phase currents I_{U}, I_{V} and I_{W} in phase coordinates. In particular, in addition to the parameters included in equation (1.1), an input term describing an electric voltage and/or a disturbance term describing an electromagnetic force of a permanent magnet of the electric machine 1 are contained in the periodic, linear time-variant differential equation. The input term and the disturbance term are preferably not taken into account according to the method shown in FIG. 4 and are therefore not included in equation (1.1) in the present case. The device 8 preferably determines the system matrix A_{abc}(t) on the basis of a finite element model of the electric machine 1. In particular, inductance harmonic waves of the electric machine 1 and angles other than 120° between the phases U, V and W are described by the finite element model, the system matrix A_{abc}(t) and the periodic, linear time-variant differential equation. The periodic, linear time-variant differential equation is therefore a precise behavior model of the electric machine 1 for selected operating points, i.e. speeds ω, variables corresponding to speeds ω or torques.

In a step S3, the device 8 determines a time-invariant differential equation on the basis of the periodic, linear time-variant differential equation by means of a Floquet transformation. This is described by the following equation (1.2).

İ_{fl}=A_{fl}I_{fl}=QI_{fl} (1.2)

In this case, Q describes a real-valued matrix and I_{fl} a current value which corresponds to the phase currents I_{U}, I_{V} and I_{W}. The current value I_{fl} represents the phase currents I_{U}, I_{V} and I_{W} in Floquet coordinates. Since the periodic, linear time-variant differential equation is a T-periodic differential equation, this can be transformed into the time-invariant differential equation according to the Floquet theory. A transformation which can be described by the following equation (1.3) then exists.

I_{fl}P(t)I_{abc} (1.3)

In this case, P(t)is a transformation matrix. This results from the fundamental matrix Φ(t), which can be represented according to the following equation (1.4) for periodic systems.

Φ(t)=P(T)e^{Qt} (1.4)

The equation (1.6) furthermore results from the mathematical association described by the following equation (1.5).

\dot{Φ}(t)=\dot{P}(t)e^{Qt}+P(t)e^{Qt}=(\dot{P}(T)+P(t)Q)e^{Qt}=A_{abc}(t)P(t)e^{Qt} (1.5)

\dot{P}=AP−PQ (1.6)

To implement or calculate the Floquet transformation, the equation (1.6) is solved. To this end, an initial value for the matrix Q is specified. Therefore, an initial value for part of the time-invariant differential equation is specified. A mean value of the system matrix A_{abc}(t) is preferably specified as an initial value.

In a step S4, the device 8 determines an error J of the time-invariant differential equation determined on the basis of the initial value. The error J is determined according to the following equation (1.7).

J=∥P(2 T)−E∥ (1.7)

In this case, E describes the unit matrix of the dimension of P(t). Owing to the periodicity of the system, it is assumed that the transformation matrix P(t) corresponds to the points in time t=0 and t=2 T of the unit matrix E.

In a step S5, the time-invariant differential equation or the matrix Q is corrected by the device 8 until the error J is smaller than a specified threshold value. To this end, a search method, in particular a downhill simplex method or a gradient method, in particular a quasi Newton method, is used in step S5, for example.

In a step S6, the device 8 determines a desired current value I_{Soll,fl} on the basis of the corrected time-invariant differential equation on the one hand and a specified torque or a specified speed on the other. The desired current value I_{Soll,fl} corresponds to the phase currents I_{U}, I_{V} and I_{W} which must flow through the phases U, V or W so that the specified torque or the specified speed is generated by the electric machine 1. The desired current value I_{Soll,fl} represents the phase currents I_{U}, I_{V} and I_{W} in phase coordinates.

In a step S7, the current phase currents I_{U}, I_{V} and I_{W} are determined. By way of example, each of the current phase currents I_{U}, I_{V} and I_{W} is detected in each case by a current measuring device and supplied to the device 8.

In a step S8, the device 8 determines an actual current value I_{Ist,fl} on the basis of the current phase currents I_{U}, I_{V} and I_{W}. The actual current value I_{Ist,fl} corresponds to the current phase currents I_{U}, I_{V} and I_{W} and represents the current phase currents I_{U}, I_{V} and I_{W} in Floquet coordinates. In this case, the actual current value I_{Ist,fl} and the desired current value I_{Soll,fl} have an identical dimension or physical unit.

In a step S9, the device 8 compares the desired current value I_{Soll,fl} to the actual current value I_{Ist,fl}. By way of example, to this end, the device 8 calculates a difference from the desired current value I_{Soll,fl} and the actual current value I_{Ist,fl}.

In a step S10, the device 8 determines a desired voltage value U_{Soll,fl} on the basis of the comparison, which desired voltage value corresponds to electric voltages which must be applied to the phases U, V or W so that the difference between the actual current value I_{Ist,fl} and the desired current value I_{Soll,fl} is reduced. The desired voltage value U_{Soll,fl} represents the voltages to be applied in Floquet coordinates.

In a step S11, the device 8 determines a desired voltage value U_{Soll,abc} on the basis of the desired voltage value U_{Soll,fl}. The desired voltage value U_{Soll,abc} represents the voltages to be applied in phase coordinates.

In a step S12, the device 8 then controls the power electronics 7 such that the voltages to be applied are applied at the phases U, V and W.

The steps S7 to S12 preferably form a control loop 9. Step S7 is then preferably referred to again following step S12.

The steps S1 to S5 preferably take place spaced in time from steps S6 to S12. By way of example, according to steps S1 to S5, a time-invariant differential equation is determined on the basis of the speed ω of the rotor 2 or a variable corresponding to the speed ω of the rotor 2, and the determined time-invariant differential equation is stored in a data memory. Corresponding variables of a time-invariant differential equation in each case are preferably determined for a plurality of speeds ω of the rotor or variables corresponding to speeds ω of the rotor 2, and the determined time-invariant differential equations are stored in the data memory. To implement the method steps S6 to S12 in a time-staggered manner, the stored time-invariant differential equation or one of the stored time-invariant differential equations is then supplied to the device 8.

1. A method for operating an electric machine (1), which has a stator (4) and a rotor (2), wherein the stator (4) has a stator winding (5) with at least three phases (U, V, W), and wherein the rotor (2) is arrangeable on a rotor shaft (3), the method comprising:
determining a desired current value (I_{Soll,fl}) of the stator winding (5) for generating a required torque and/or a required speed on the basis of a time-invariant differential equation modeling the machine (1),
comparing the desired current value (I_{Soll,fl}) is compared with an actual current value (I_{Ist,fl}) of the stator winding (5), which corresponds to electric phase currents (I_{U}, I_{V}, I_{W}) flowing through the phases (U, V, W), and
energizing, on the basis of the comparison, the phases (U, V, W) such that a deviation of the actual current value (I_{Ist,fl}) from the desired current value (I_{Soll,fl}) is reduced, wherein the time-invariant differential equation is determined on the basis of a periodic, linear time-variant differential equation by means of a Floquet transformation.

2. The method as claimed in claim 1, wherein the periodic, linear time-variant differential equation is determined on the basis of a speed (ω) and/or a torque of the electric machine (1).

3. The method as claimed in claim 1, wherein the periodic, linear time-variant differential equation is determined on the basis of a system matrix (A_{abc}(t)) of the electric machine (1), which describes an angle-dependent inductance of the stator winding (5).

4. The method as claimed in claim 3, wherein the system matrix (A_{abc}(t)) of the electric machine (1) is determined on the basis of a finite element model of the electric machine (1).

5. The method as claimed in claim 1, wherein, to implement the Floquet transformation, an initial value is specified, wherein the time-invariant differential equation is determined on the basis of the initial value.

6. The method as claimed in claim 5, wherein a mean value of the system matrix (A_{abc}(t)) is specified as the initial value.

7. The method as claimed in claim 5, wherein an error (J) of the time-invariant differential equation determined on the basis of the initial value is determined and in that the time-invariant differential equation is corrected until the error (J) is smaller than a specified threshold value.

8. The method as claimed in claim 7, wherein the time-invariant differential equation is corrected on the basis of a downhill simplex method.

9. The method as claimed in claim 7, wherein the time-invariant differential equation is corrected on the basis of a quasi-Newton method.

10. A device (8) for an electric machine (1), wherein the machine (1) has a stator (4) and a rotor (2), wherein the stator (4) has a stator winding (5) with at least three phases (U, V, W), and wherein the rotor (2) is arrangeable on a rotor shaft (3), wherein the device (8) comprises a control unit (8) configured to
determine a desired current value (I_{Soll,fl}) of the stator winding (5) for generating a required torque and/or a required speed on the basis of a time-invariant differential equation modeling the machine (1),
compare the desired current value (I_{Soll,fl}) with an actual current value (I_{Ist,fl}) of the stator winding (5), which corresponds to electric phase currents (I_{U}, I_{V}, I_{W}) flowing through the phases (U, V, W), and
energize, on the basis of the comparison, the phases (U, V, W) such that a deviation of the actual current value (I_{Ist,fl}) from the desired current value (I_{Soll,fl}) is reduced, wherein the time-invariant differential equation is determined on the basis of a periodic, linear time-variant differential equation by means of a Floquet transformation.
